(19) United States
(12) Patent Application Publication
(10) Pub. No.: US 2009/0240534 A1
(43) Pub. Date: Sep. 24, 2009

(54) SYSTEM AND METHOD FOR ALIGNING TERRITORIES

(76) Inventor: Lawrence Koa, Dublin, CA (US)

Correspondence Address: IAN F. BURNS & ASSOCIATES, 4790 Caughlin Parkway #701, RENO, NV, 89519-0907, US

(21) Appl. No.: 12/407,549

(22) Filed: Mar. 19, 2009

Related U.S. Application Data
(60) Provisional application No. 61/038,177, filed on Mar. 20, 2008.

(51) Int. Cl. G06Q 40/00; G06Q 10/00; G06F 17/30; G06F 17/40

(52) U.S. Cl. 705/4; 705/7; 707/104.1; 707/3; 707/E17.018; 707/E17.044

(57) ABSTRACT

In competitive pricing analysis, a system and method aligns territory definitions for a plurality of insurance companies. Each territory definition may be mapped for a region and interest and then aligned to determine the uniquely aligned territories. Each uniquely aligned territory identifies only a single territory of a company's territory definition, allowing an accurate comparison of insurance premiums rates to be made between insurance companies for the uniquely aligned territory.

### CROSS REFERENCE TO RELATED APPLICATIONS

This application claims priority to U.S. provisional patent application Ser. No. 61/038,177, filed Mar. 20, 2008, the contents of which is herein incorporated by reference.

### FIELD OF THE INVENTION

The present invention relates to competitive pricing analysis and in particular to competitive pricing analysis for territorial based services such as vehicle insurance premiums.

### BACKGROUND

A vehicle's garaging address is one of the major determining factors of a vehicle's insurance premium because different areas or regions have different demographics that could affect the loss potential of a risk. Some demographics used are accident occurrence, crime rates and population densities. Insurance companies have demonstrated that certain regions or areas have higher occurrences of loss due to these demographics. For example, areas of higher population densities have a higher risk of loss due to accidents and areas with higher crime rates result in a higher risk of loss due to theft and vandalism.

To stay competitive in the market place by allowing companies to price a policy that is more reflective of loss potential, companies have adopted territorial rating. Territorial rating is when companies assign territories to certain areas or regions and based on that territory's demographics assign a factor or a base rate that best reflects that territory's loss potential. Since the determination and justification for these territories are from the insurance company, the number of territories and the actual boundary for each territory is unique from company to company. For the state of New York for instance, the number of territories can range from as low as 60 to as high as 130+ unique territories. How the boundaries for each territory are defined for a particular company, can be as simple as a zip code to territory table or can get as complex as boundaries defined by city limits, county limits, townships, streets, highways or geographic boundaries, such as mountains, lakes or rivers.

Given the complexities and uniqueness of territories and their boundaries for each company, the challenge introduced to the competitive pricing analyst is to determine which of the competitor territory or territories should be used when trying to compare rates for each of the analyst's company territories. To add to this challenge, competitive pricing reports often require that these reports are summarized by zip code, city or county. This means, the analyst would have to be able to determine which of the company territories to use when pricing a particular zip code, city or county.

What is required is a system and method for aligning the territories of various companies against each other and also against particular zip codes and similar boundaries.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to identity uniquely aligned territories for different companies; and

provide a comparison of ratings for territories within a region of interest such as a zip code.

These and other advantages may be realized by reference to the remaining portions of the specification, claims, and abstract.

### BRIEF DESCRIPTION OF ONE EMBODIMENT OF THE PRESENT INVENTION

In one aspect, the invention relates to a method for aligning territory definitions of a plurality of insurance companies. In the method, at least first and second territory definitions are mapped for a region of interest. The territory definitions are aligned and the uniquely aligned territories are determined.

In one aspect, the invention relates to a system for aligning a plurality of territory definitions comprising at least one mapping tool and at least one database. The mapping tool is configured to map a first territory definition and a second territory definition on the region of interest. The mapping tool allows a user to align the first territory definition and the second territory definition and to define one or more uniquely aligned territories. A definition of the one or more uniquely aligned territories may be stored in the database.

In one aspect, the invention relates to a system for processing a plurality of territory definitions for a plurality of insurance companies comprising means for aligning the plurality of territory definitions and means for defining the uniquely aligned territories of the plurality of territory definitions.

In one aspect, the invention relates to a method for determining one or more aligned territories comprising receiving a location indicator, executing a query on the database using the location indicator as an index, and retrieving from the database at least one territory indicator associated with the location indicator.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of a territory alignment system;

FIG. 2 is substantially a flowchart of a territory alignment process;

FIG. 3 is substantially a table of territory definitions for a first company;

FIG. 4 is substantially a table of territory definitions for a second company;

FIG. 5 is substantially a zip code map;

FIG. 6 is substantially a territory map for the first company;

FIG. 7 is substantially a territory map for the second company;

FIG. 8 is an overlaid territory map for the first and second companies; and

FIG. 9 is a split boundary table for the overlaid territory map of FIG. 8.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

A system in accordance with an embodiment of the invention is illustrated in FIG. 1. In the system 10, a host 12, such as from a competitive pricing analyst, interfaces with a database 14 that stores territory information for a plurality of companies, such as insurance carriers. The territory information may be received from the companies, e.g. company A 21 and company B 22, by the host 12 through suitable communications links 23, such as the internet, File Transfer Protocols (FTP), phone links, interactive voice response systems or any suitable communications links. Alternatively, the territory information may be obtained from an external resource and entered into database 14 via the host 12. In one embodiment, the host 12 may include a processor, graphical user interface, server and/or other computing components.

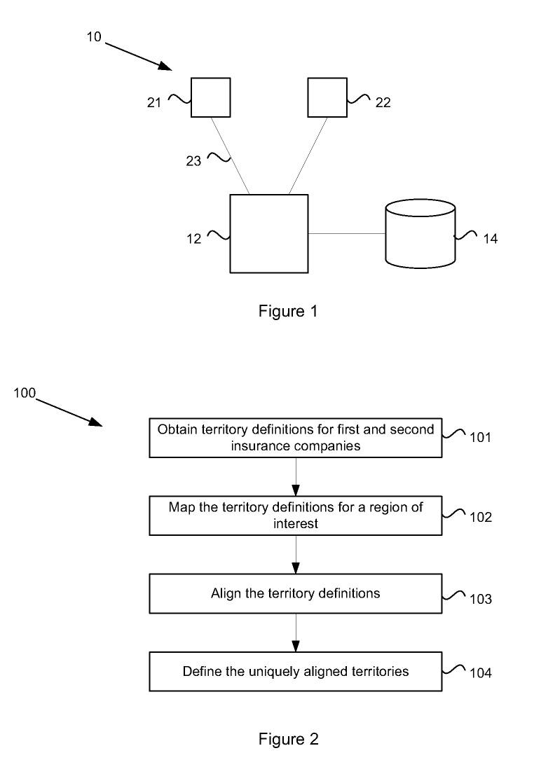

A process for territory alignment is depicted in the flowchart 100 of FIG. 2. At step 101, territory definitions for first and second insurance companies are obtained. At step 102, the territory definitions are mapped onto a region of interest. At step 103, the territory definitions are aligned, allowing a user to define the uniquely aligned territories at step 104.

In one embodiment, a map containing the boundaries defined by the territory definitions for a number of companies is obtained. The actual boundaries for each territory are then drawn on the map. The complexity of the boundaries needed in the map depend mainly on which company the maps are being drawn for. Some companies define territories based on cities, counties, townships, street, highway or even geographic boundaries. Thus, the map should contain these boundaries to be able to draw an accurate map. Once the territory maps are drawn, they can be overlaid to determine what territory or territories to use for each particular zip code for the relevant companies.

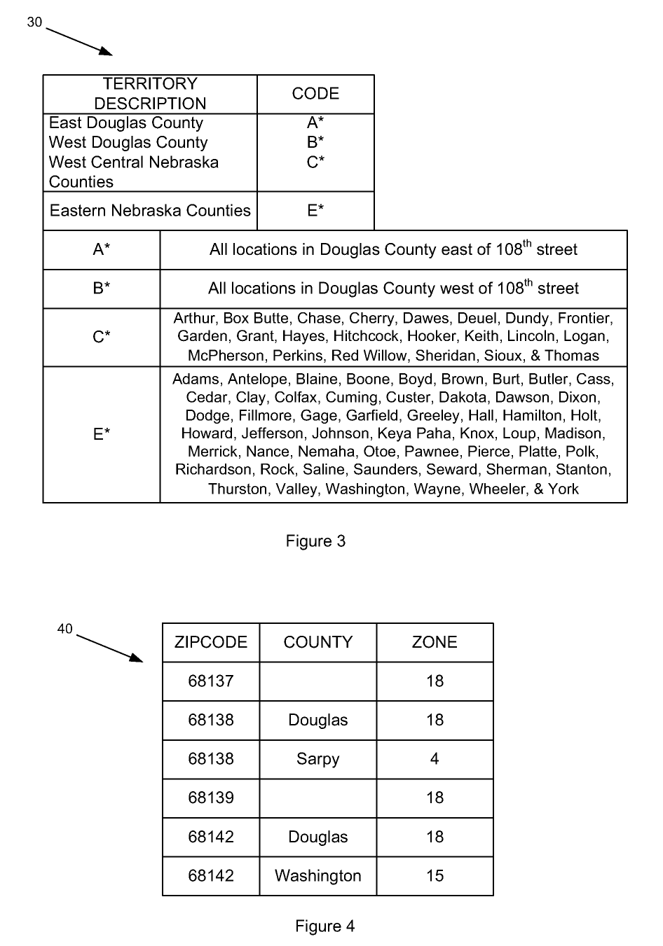

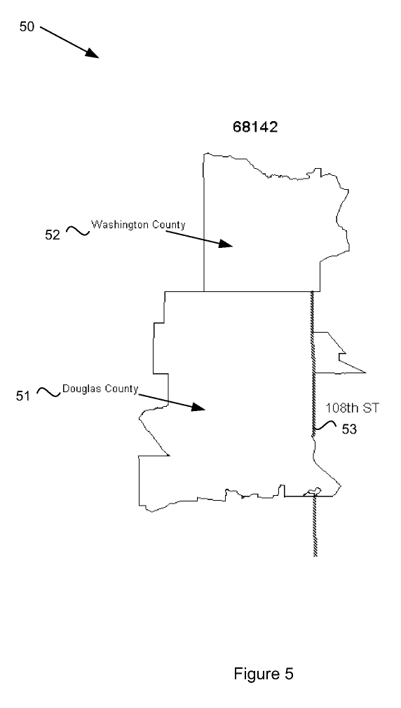

In order to provide a specific example of territory alignment, an example of two companies operating territories in zip code 68142 of Nebraska will be described. In FIG. 3 there is shown the territory definitions for Company 1. In FIG. 4 there is shown the territory definitions for Company 2. A map 50 showing zip code 68142 is shown in FIG. 5. The map 50 may be extracted from the database 14 or from various online mapping resources.

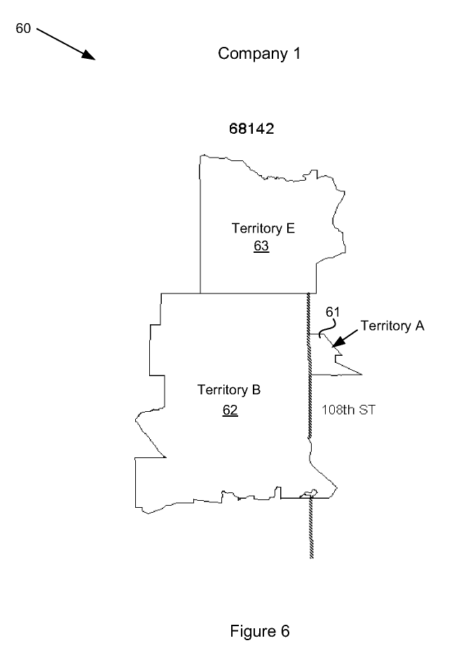

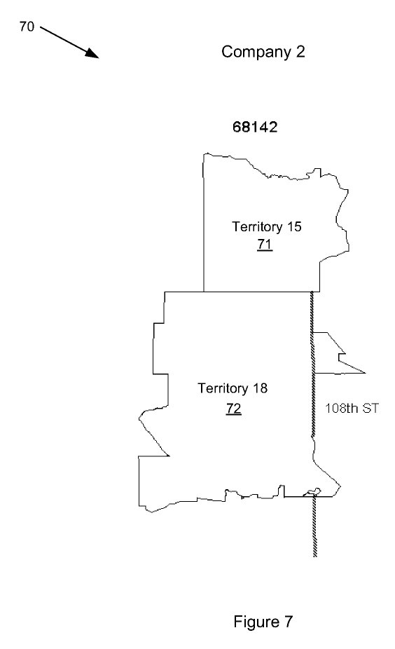

From the map 50, it can be seen that zip code 68142 crosses over two counties, Douglas 51 and Washington 52. Added to the map, is the location of 108th Street 53 as this street serves as a boundary for territories A and B of Company 1 and also crosses thru zip code 68142. Using the map 50 of FIG. 5 and the respective territory definitions, territory maps may be produced. In one embodiment, the territory maps may be produced using mapping tools including proprietary mapping software such as ArcView. In FIG. 6, there is shown a territory map 60 for Company 1 produced from the zip code map 50 and the territory definitions 30 of FIG. 3. From the territory map 60, it can be seen that zip code 68142 is in three territories for Company 1, namely territory A 61, territory B 62 and territory E 63. In FIG. 7, there is shown a territory map 70 for Company 2 produced from the zip code map 50 and the territory definitions 40 of FIG. 4. From the territory map 70, it can be seen that zip code 68142 is in two territories for Company 2, namely territory 15 (71) and territory 18 (72).

It is shown that for the region of interest, zip code 68142, a 3:2 mapping for Company 1 and Company 2 is produced. If insurance quotes were to be obtained using only the regions defined by the respective companies, a comparison between quotes may not be accurate because a quote obtained for territory 18 of Company 2 may be competitive when compared to a quote for the territory A of Company 1 but not competitive when compared to a quote for territory B of Company 1. It is therefore necessary to produce uniquely aligned sub-territories for which a 1:1 mapping exists.

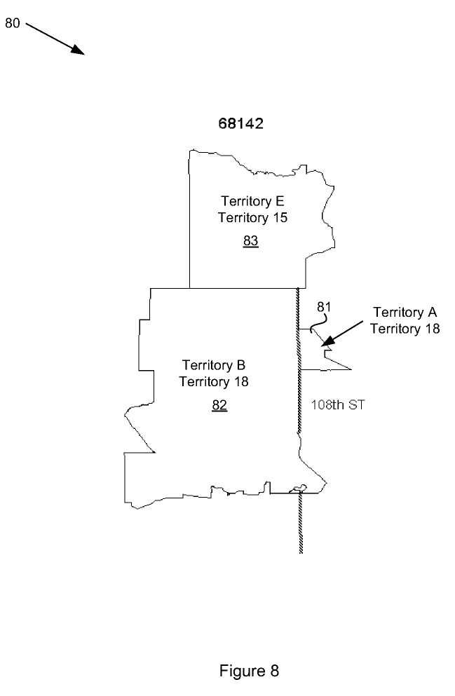

Aligning the territory map 60 with territory map 70 produces an aligned map 80 as shown in FIG. 8, which shows three unique aligned territories 81, 82, 83. In the alignment process, there may be common territory boundaries, such as portions of the border of zip code 68142, which are common to the territory definition of each company. There may also be non-common territory boundaries, such as 108th Street, that form territory boundaries for only one territory definition (or a subset of the territory definitions where more than two companies are being analyzed). Each non-common territory boundary will have the effect of dividing the region of interest into a sub-territory. Each sub-territory that is only bordered by the territory definitions, i.e. has no territory definitions within the sub-territory, may be considered to be uniquely aligned. To paraphrase, each uniquely aligned territory covers only one territory of the territory definitions of each company involved in the analysis.

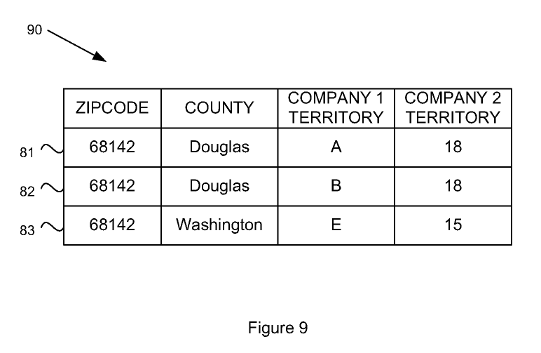

The alignment may be performed using mapping tools as mentioned above. The uniquely aligned territories may be, summarized in a table, such as Table 90 shown in FIG. 9. Table 90 shows that to effectively rate zip code 68142 for Company 1 and Company 2, the three uniquely aligned territories must be rated. Each uniquely aligned territory, i.e. each row of table 90 may be considered as a split boundary. The alignment divides the region of interest into sub-territories with a 1:1 mapping of the sub-territories. That is, sub-territories A-18, B-18 and E-15 may be considered as unique in the aligned mapping.

The above example shows an alignment for two companies in one zip code. As an evaluation takes into account more companies and more territory definitions, the resulting split boundary table can become more complex with many additional rows being required to uniquely identify each aligned territory.

Territory alignment data may be generated and stored in the database 14. Using the territory alignments, a company may be better placed to determine its competitive position with respect to other companies of interest. For example, a user interfacing through the host 12, may enter a company name and/or location indicator such as a zip code, company specific territory name or number, or a geographical features such as a suburb, street name or similar identifier. Using this information, the host 12 may execute a query on the database 14 that returns the relevant territory information for the company entered by the user. Because the territories are uniquely aligned, a location indicator will uniquely identify the territory covering the location indicator. In addition, the query may return territory information of other companies that aligns with the information entered by the user, thus allowing the user to analyze how other companies rate a particular territory, how other companies break down a zip code into territories, and similar information that may assist the user in performing a competitive price analysis. The database queries may allow a user to filter the results. For example, a user may specify to see how the territories of specific companies align and so the alignment data for other companies will be omitted.

By obtaining insurance premium quotes for each of the uniquely aligned territories for each of the companies in the study, a user such as a competitive pricing analyst is able to make accurate comparisons between quotes.

While the maps depicted show maps in a graphic form, in an alternative embodiment, the maps may be depicted as a mapping of boundary elements, such as in a tabled form, that identify and tabulate the borders of the split boundaries.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for aligning territory definitions of a plurality of insurance companies comprising:
(A) obtaining a first territory definition for a first insurance company;
(B) obtaining a second territory definition for a second company;
(C) determining a region of interest;
(D) mapping the first territory definition for the region of interest;
(E) mapping the second territory definition for the region of interest;
(F) aligning the mapping of the first territory definition with the mapping of the second territory definition; and
(G) determining the uniquely aligned territories.

2. The method of claim 1 wherein the first territory definition and the second territory definition each define one or more boundaries of one or more territories within the region of interest.

3. The method of claim 2 wherein determining the uniquely aligned territories comprises determining one or more sub-territories within the region of interest for which the sub-territory contains none of the one or more boundaries within the sub-territory.

4. The method of claim 2 wherein determining the uniquely aligned territories comprises determining at least one sub-territory within the region of interest for which the sub-territory maps to only one territory of each of the first territory definition and the second territory definition.

5. The method of claim 4 wherein determining the uniquely aligned territories comprises determining each sub-territory within the region of interest for which the respective sub-territory maps to only one territory of each of the first territory definition and the second territory definition.

6. The method of claim 1 comprising:
(A) determining a first insurance premium in a first uniquely aligned territory for the first insurance company;
(B) determining a second insurance premium in the first uniquely aligned territory for the second insurance company; and
(C) comparing the first insurance premium and the second insurance premium.

7. The method of claim 6 comprising determining an insurance premium for the first company and for the second company for each uniquely aligned territory.

8. The method of claim 1 comprising generating a uniquely aligned territory table that associates each uniquely aligned territory with a territory of each territory definition.

9. The method of claim 8 comprising storing the uniquely aligned territory table in a database.

10. The method of claim 9 comprising:
(A) receiving a location indicator of a location within the region of interest;
(B) executing a database query on the aligned territory table using the location indicator as an index; and
(C) retrieving the uniquely aligned territories for the first company and the second company associated with the location indicator.

11. The method of claim 10 wherein the location indictor comprises a territory of the first territory definition or the second territory definition.

12. The method of claim 8 comprising displaying the aligned territory table.

13. The method of claim 1 comprising:
(A) obtaining a third territory definition for a third insurance company;
(B) mapping the third territory definition for the region of interest; and
(C) aligning the mappings of the first territory definition, the second territory definition and the third territory definition; and
(D) determining the uniquely aligned territories.

14. A system for aligning a plurality of territory definitions comprising:
(A) at least one mapping tool configured to:
(a) map a region of interest;
(b) map a first territory definition on the region of interest;
(c) map a second territory definition on the region of interest;
(d) allow a user to align the first territory definition and the second territory definition; and
(e) allow a user to define one or more uniquely aligned territories; and
(B) at least one database configured to store a definition of the one or more uniquely aligned territories.

15. The system of claim 14 comprising:
(A) an interface configured to allow a user to enter a location indicator; and
(B) at least one processor configured to:
(a) execute a query on the database using the location indicator as an index; and
(b) retrieve from the database at least one territory associated with the location indicator.

16. The system of claim 15 wherein the at least one processor is configured to retrieve each territory that is associated with the location indicator.

17. A system for processing a plurality of territory definitions for a plurality of insurance companies comprising:
(A) means for aligning the plurality of territory definitions; and
(B) means for defining the uniquely aligned territories of the plurality of territory definitions.

18. The system of claim 17 comprising means for dividing the region of interest into a plurality of sub-territories, wherein each sub-territory identifies a single territory of each of the plurality of territory definitions.

19. A method for determining one or more aligned territories comprising:
(A) receiving a location indicator;
(B) executing a query on the database using the location indicator as an index; and
(C) retrieving from the database at least one territory indicator associated with the location indicator.

20. The method of claim 19 comprising retrieving each territory indicator that is associated with the location indicator.

21. The method of claim 20 wherein the each retrieved territory indicator is uniquely associated with a territory definition.

22. The method of claim 21 wherein each territory definition is uniquely associated with an insurance company.
